(19) United States
(12) Patent Application Publication
(10) Pub. No.: US 2014/0001941 A1
(43) Pub. Date: Jan. 2, 2014

(54) HINGE MECHANISM AND CLAMSHELL DEVICE THEREOF

(71) Applicants: Chen-Yi LIANG, New Taipei City (TW); Cheng-Hsiang Chuang, New Taipei City (TW); Wen-Tai Lin, New Taipei City (TW)

(72) Inventors: Chen-Yi LIANG, New Taipei City (TW); Cheng-Hsiang Chuang, New Taipei City (TW); Wen-Tai Lin, New Taipei City (TW)

(21) Appl. No.: 13/539,653

(22) Filed: Jul. 2, 2012

(51) Int. Cl. E05D 11/04; A47B 81/00

(52) U.S. Cl. 312/327; 16/275

(57) ABSTRACT

A hinge mechanism and a clamshell device thereof are disclosed. A first cover body of the clamshell device can rotate with respect to a second cover body via the hinge mechanism. The hinge mechanism includes a bearing, a first rotating element, a second rotating element, and a base. The first rotating element includes a first jointed structure pivotally connected to the bearing. The second rotating element includes a protruding element and is pivotally connected to the first rotating element via a second jointed structure. The base includes a groove for the protruding element to slide in the groove. When the first rotating element and the second rotating element rotate, the protruding element moves from a first end to a second end of the groove to let the first jointed structure, second jointed structure and the protruding element form a three-point support structure.

### BACKGROUND OF THE INVENTION

1. Field of the Invention

The present invention relates to a hinge mechanism and a clamshell device using the same, and more particularly, to a hinge mechanism having a three-point support structure and a clamshell device using the same.

2. Description of the Related Art

Of all the mechanical devices, clamshell devices are now frequently used in daily lives. In a clamshell device, the first cover body and the second cover body are mutually connected with each other through a hinge mechanism to let the first cover body and the second cover body rotate with respect to each other. While the clamshell device comprises a bearing to sustain torsion force, it often uses a gasket structure or a double coated structure to achieve the purpose. However, both the gasket structure and the double coated structure comprise only one single support at the bearing, which is the shaft. As there's only one single support, the first cover body and the second cover body tend to be shaky when they move with respect to each other. If one of the cover bodies is a touch panel, operations on the touch panel could be affected by the shaky moves of the cover bodies. In a prior art technique, the shaft would have its size increased when it needs to support the cover bodies to withstand increasing torsion force. However, since a larger shaft takes up more space in the clamshell device; it is not suitable for designing the clamshell device having a thinner and lighter form factor.

### SUMMARY OF THE INVENTION

It is an object of the present invention to provide a hinge mechanism having a three-point support structure.

It is also an object of the present invention to provide a clamshell device using the hinge mechanism having a three-point support structure.

In order to achieve the above object, a hinge mechanism of the present invention comprising a bearing, a first rotating element, a second rotating element, and a base. The first rotating element comprises a first jointed structure pivotally connected to the bearing. The second rotating element is pivotally connected to the first rotating element via a second jointed structure, and the second rotating element comprises a protruding element. The base comprises a groove having a size corresponded with a size of the protruding element for the protruding element to slide in the groove. The groove comprises a first end and a second end; when the first rotating element and the second rotating element rotate via the first jointed structure and the second jointed structure respectively, the protruding element moves from the first end to the second end to let the first jointed structure, second jointed structure and the protruding element form a three-point support structure.

The present invention also discloses a clamshell device operable in an open state and a closed state, the clamshell device comprising a first cover body; a second cover body; and a hinge mechanism connected with the first cover body and the second cover body respectively to let the first cover body and the second cover body rotate with respect to each other. The hinge mechanism comprises a bearing, a first rotating element, a second rotating element, and a base. The bearing is disposed on the second cover body. The first rotating element comprises a first jointed structure pivotally connected to the bearing for the first rotating element to rotate with respect to the bearing. The second rotating element is pivotally connected to the first rotating element via a second jointed structure for the second rotating element to rotate with respect to the first rotating element, wherein the second rotating element comprises a protruding element. The base is disposed on the second cover body, the base comprising a groove, wherein the groove has a size corresponded with a size of the protruding element for the protruding element to move in the groove, the groove comprises a first end and a second end; when the first cover body and the second cover body rotate with respect to each other, the first rotating element and the second rotating element rotate via the first jointed structure and the second jointed structure respectively, and the protruding element moves from the first end to the second end to let the first jointed structure, second jointed structure and the protruding element form a three-point support structure.

### BRIEF DESCRIPTION OF THE DRAWINGS

FIG. 1 illustrates an explosive view of a first embodiment of a hinge mechanism of the present invention;

FIG. 2A-2C illustrate an operation view of the first embodiment of the hinge mechanism of the present invention;

FIG. 3A illustrates a closed state of the clamshell device having the hinge mechanism in a first embodiment of the present invention;

FIG. 3B illustrates an open state of the clamshell device having the hinge mechanism in the first embodiment of the present invention;

FIG. 4A illustrates a closed state of the clamshell device having the hinge mechanism in a second embodiment of the present invention;

FIG. 4B illustrates an open state of the clamshell device having the hinge mechanism in the second embodiment of the present invention;

FIG. 5A illustrates a closed state of the clamshell device having the hinge mechanism in a third embodiment of the present invention; and

FIG. 5B illustrates an open state of the clamshell device having the hinge mechanism in a third embodiment of the present invention.

### DETAILED DESCRIPTION OF THE PREFERRED EMBODIMENTS

The advantages and innovative features of the invention will become more apparent from the following detailed description when taken in conjunction with the accompanying drawings.

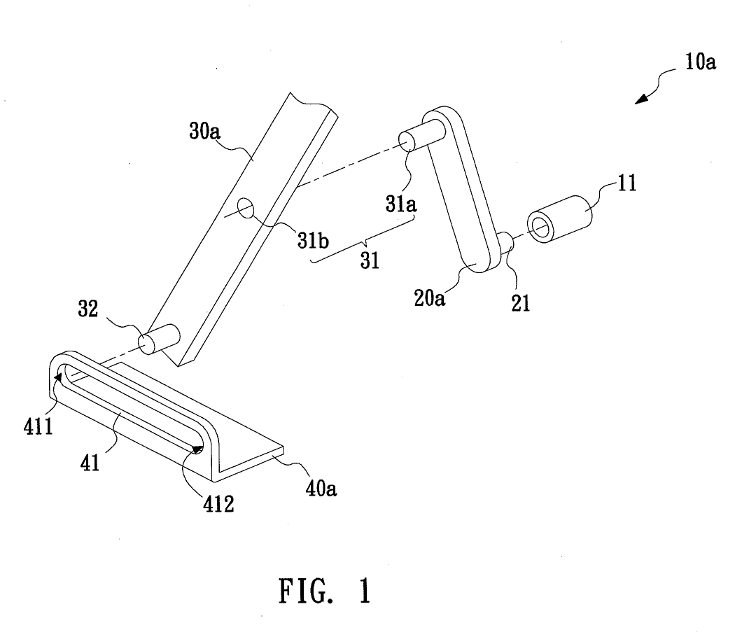

Please refer to FIG. 1 for an explosive view of a first embodiment of a hinge mechanism of the present invention.

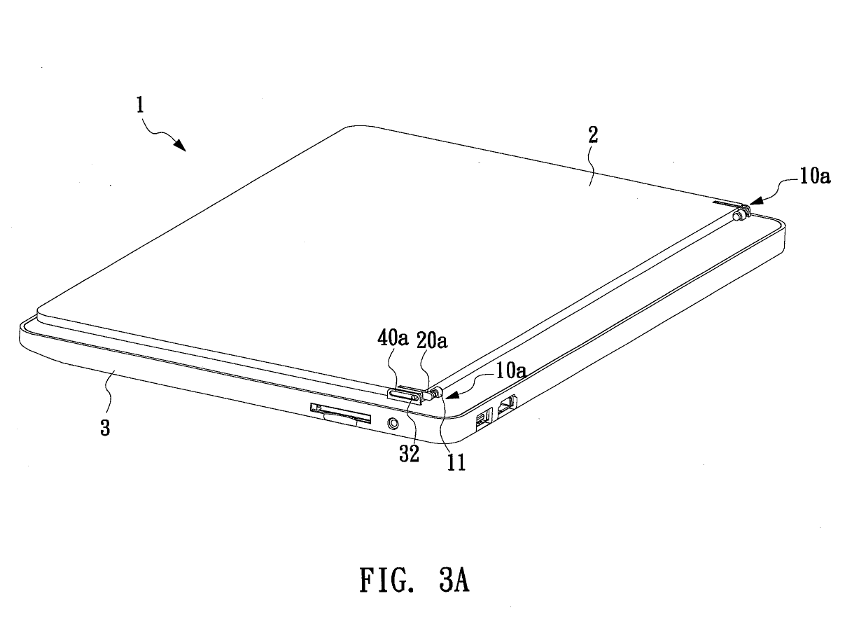

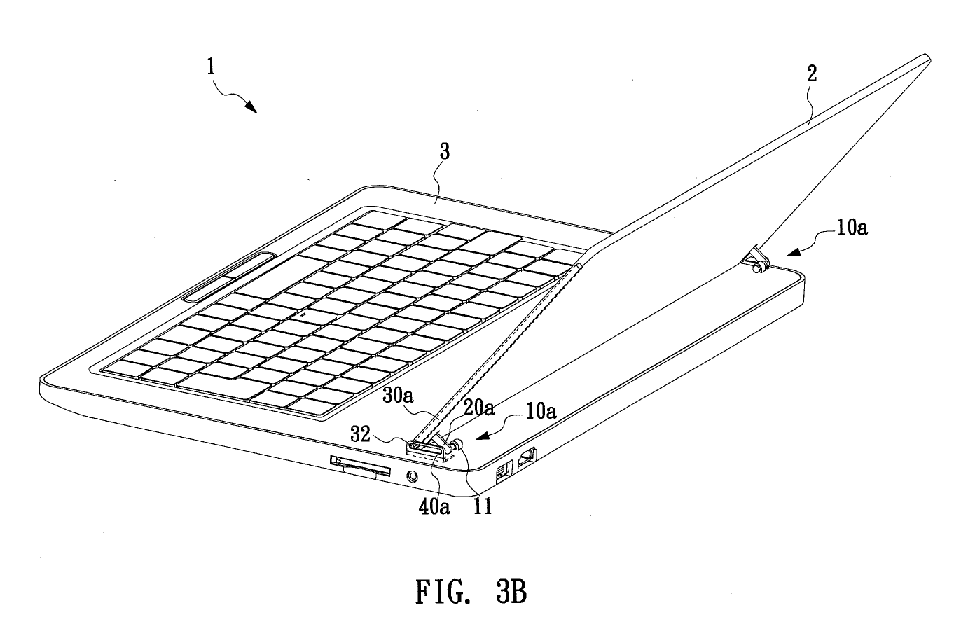

A hinge mechanism 10a can be used in a clamshell device 1 (as shown in FIG. 3A), and the hinge mechanism 10a can also be used in other types of devices. The hinge mechanism 10a comprises a bearing 11, a first rotating element 20a, a second rotating element 30a, and a base 40a. The bearing 11 can be disposed on the base 40a to enhance the total strength of the hinge mechanism 10a, and the bearing 11 can also be disposed in other suitable positions. The first rotating element 20a comprises a first jointed structure 21 pivotally connected to the bearing 11 to let the first rotating element 20a rotate with respect to the bearing 11. The second rotating element 30a is pivotally connected to the first rotating element 20a via the second jointed structure 31 to be rotatable with respect to the first rotating element 20a.

Each one of the first jointed structure 21 and the second jointed structure 31 can be a combination of a convex portion and a hole. As shown by the second jointed structure 31 of FIG. 1, the second jointed structure 31 comprises a convex portion 31 a disposed on the first rotating element 20a and a hole 31b disposed in the second rotating element 30a. When the convex portion 31 a is connected to the hole 31b, the second rotating element 30a and the first rotating element 20a can be pivotally connected to each other and they can rotate with respect to each other. It is noted that the combination of the first jointed structure 21 and the second jointed structure 31 is intended only for illustration. The first jointed structure 21 and the second jointed structure 31 can use a nut/screw or other fastening mechanism to generate torsion force; however, the first jointed structure 21 and the second jointed structure 31 can be designed as a torsion-less structure when used in combination.

The second rotating element 30a further comprises a protruding element 32 to cooperate with a groove 41 of the base 40a. The groove 41 comprises a first end 411 and a second end 412 for the protruding element 32 to slide between the first end 411 and the second end 412 of the groove 41. Besides, the protruding element 32 can further comprise a nut to push against each side of the groove 41 to increase friction between the protruding element 32 and the groove 41, making the hinge mechanism 10a more endurable to the increasing torsion force.

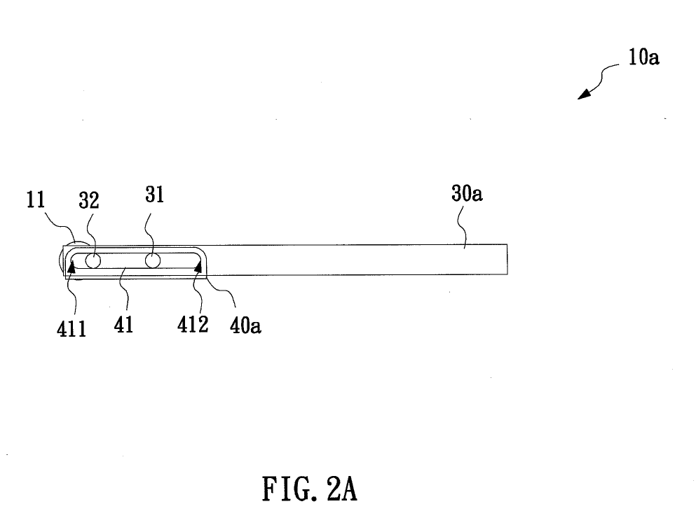

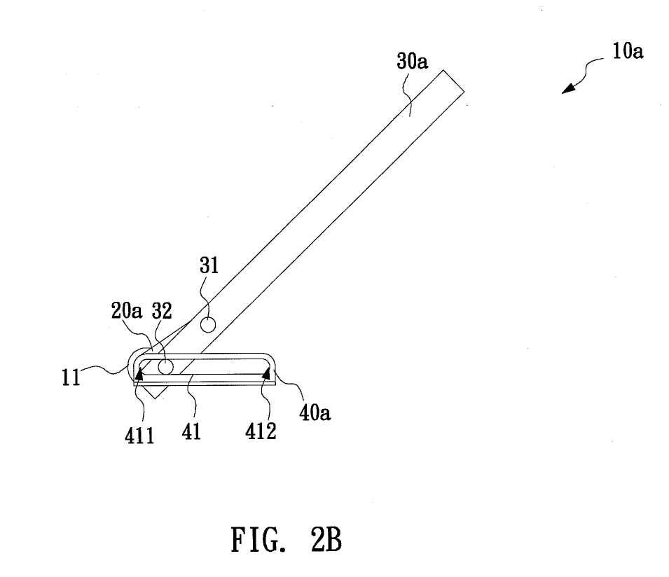

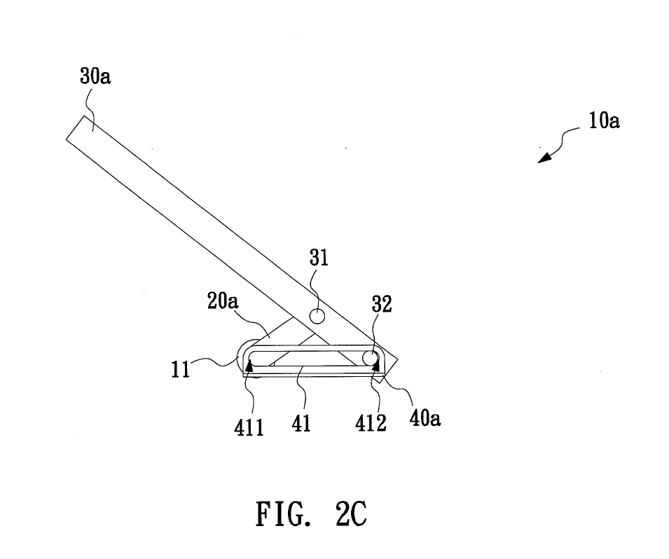

Please refer to FIG. 2A-2C for an operation view of the first embodiment of the hinge mechanism of the present invention.

As shown in FIG. 2A, when the hinge mechanism 10a hasn't started to rotate, the first rotating element 20a, the second rotating element 30a, and the groove 41 of the base 40a are on the same horizontal plane and substantially form a straight line. At this time the protruding element 32 is near the first end 411 of the groove 41. When the hinge mechanism 10a starts to rotate, the second rotating element 30a drives the first rotating element 20a to rotate base on the first jointed structure 21. Meanwhile, the first rotating element 20a and the second rotating element 30a can rotate with respect to each other via the second jointed structure 31. At this time, the operation of the hinge mechanism 10a is shown in FIG. 2B.

When the first rotating element 20a and the second rotating element 30a rotate with respect to each other, the protruding element 32 of the second rotating element 30a moves along the groove 41, sliding from a position near the first end 411 of the groove 41 to the second end 412. The second end 412 leans against the protruding element 32 for the hinge mechanism 10a to withstand torsion force. Finally, when the hinge mechanism 10a rotates to a designated position, the operation is shown in FIG. 2C. In this state, the hinge mechanism 10a is supported by a three-point support structure formed by the first jointed structure 21, the second jointed structure 31, and the protruding element 32, wherein the first rotating element 20a also supports the second rotating element 30a.

Please refer to FIG. 3A and FIG. 3B, wherein FIG. 3A illustrates a closed state of the clamshell device having the hinge mechanism in a first embodiment of the present invention; FIG. 3B illustrates an open state of the clamshell device having the hinge mechanism in the first embodiment of the present invention.

The clamshell device 1 comprises the first cover body 2, the second cover body 3 and the bearing 10a; the bearing 10a is connected with the first cover body 2 and second cover body 3 to enable the clamshell device 1 to operate in a closed state and an open state. For example, the clamshell device 1 can be a notebook PC, a mobile phone, or other devices, while the clamshell device 1 is illustrated by a notebook PC in FIG. 2A and FIG. 2B, and the first cover body 2 is the upper cover of the notebook PC, second cover body 3 is the lower cover of the notebook PC, the clamshell device 1 can have other implementations. Furthermore, the clamshell device 1 is not necessary an electronic device. In the first embodiment of the present invention, the clamshell device 1 comprises two bearings 10a, but the clamshell device 1 can have any number of bearings 10a (not limited to a single one or two) according to practical requirements.

In the first embodiment of the present invention, the second rotating element 30a of the hinge mechanism 10a is disposed inside the first cover body 2; the bearing 11 and the base 40a are disposed on the second cover body 3. In FIG. 3A and FIG. 3B, the bearing 11 and the base 40a are disposed on top of the second cover body 3, but they can disposed at any suitable positions, such as the inside of the second cover body 3, to provide a consistent and integrated look of the clamshell device 1. When the clamshell device 1 is in the closed state, the protruding element 32 of the second rotating element 30a is disposed at the first end 411 of the groove 41. When the clamshell device 1 is to be opened, the second rotating element 30a drives the first rotating element 20a to rotate and the protruding element 32 moves from the first end 411 of the groove 41 to the second end 412. Hence, the first jointed structure 21, the second jointed structure 31, and the protruding element 32 form a three-point support structure to hold the first cover body 2. On the other hand, when the first cover body 2 and the second cover body 3 rotate with respect to each other to enter the closed state, the second rotating element 30a also drives the first rotating element 20a to rotate to let the protruding element 32 move from the second end 412 to the first end 411.

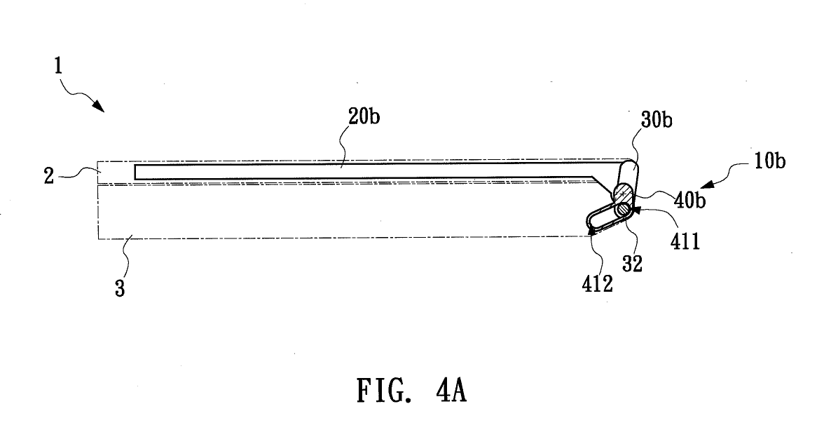

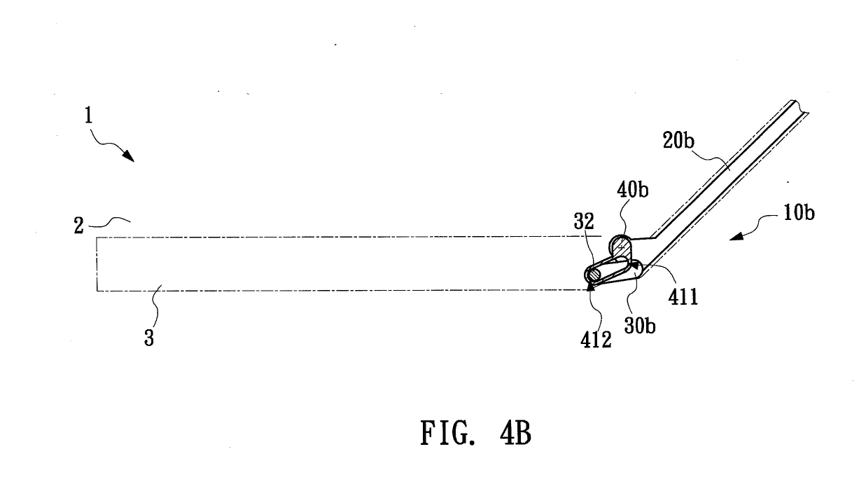

Please refer to FIG. 4A and FIG. 4B, wherein FIG. 4A illustrates a closed state of the clamshell device having the hinge mechanism in a second embodiment of the present invention; FIG. 4B illustrates an open state of the clamshell device having the hinge mechanism in the second embodiment of the present invention.

In the second embodiment of the present invention, the first rotating element 20b of the hinge mechanism 10b is disposed inside the first cover body 2, the groove 41 of the base 40b is tilted with a specific angle, so when the first cover body 2 is to rotate to an open state, the first rotating element 20b drives the second rotating element 30b to rotate therewith, the protruding element 32 of the second rotating element 30b pushes against the second end 412 of the groove 41 to be supported by the groove 41. In the meantime, since the groove 41 is tilted by the specific angle, when the first cover body 2 rotates, the second rotating element 30b rotates along with the first cover body 2. As shown in FIG. 4B, when the first cover body 2 rotates to an open position, the hinge mechanism 10b would rotate to a position under the second cover body 3. Therefore, the hinge mechanism 10b of the second embodiment can work with the clamshell device 1 having different designs.

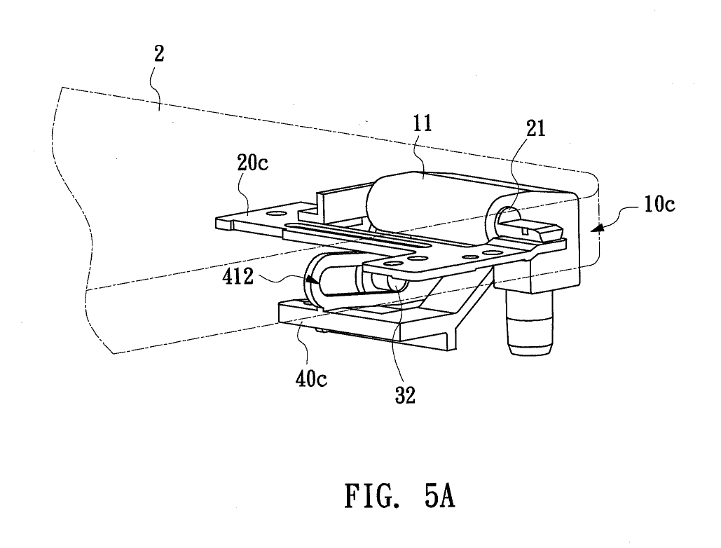

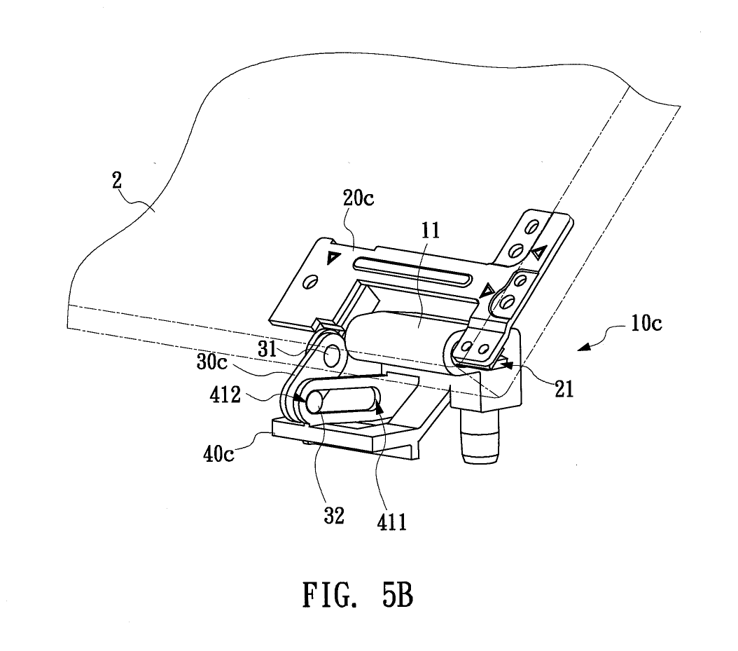

Please refer both FIG. 5A and FIG. 5B, wherein FIG. 5A illustrates a closed state of the clamshell device having the hinge mechanism in a third embodiment of the present invention; and FIG. 5B illustrates an open state of the clamshell device having the hinge mechanism in the third embodiment of the present invention.

In the third embodiment of the present invention, the first rotating element 20c of the hinge mechanism 10c is formed in an h-like shape and disposed inside the first cover body 2, but the first rotating element 20c can have other kind of shapes. The bearing 11 is disposed on the base 40c and is pivotally connected to the inner side of the first rotating element 20c via the first jointed structure 21. The second rotating element 30c is also pivotally connected to the inner side of the first rotating element 20c via the second jointed structure 31. When the first cover body 2 rotates to an open state, the second rotating element 30c is driven by the rotation of the first rotating element 20c to let the protruding element 32 of the second rotating element 30c move to the second end 412 of the groove 41. Hence, the first jointed structure 21, the second jointed structure 31, and the protruding element 32 can also form a three-point support structure to hold the first cover body 2.

From the descriptions above, the hinge mechanism 10a, 10b, and 10c can sustain larger torsion force through the three-point support structure without the need of using larger hinge, thereby reducing the size of the hinge mechanism and making it suitable for the clamshell device 1 having little containing space.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A hinge mechanism comprising:
a bearing;
a first rotating element comprising a first jointed structure pivotally connected to the bearing for the first rotating element to rotate with respect to the bearing;
a second rotating element pivotally connected to the first rotating element via a second jointed structure for the second rotating element to rotate with respect to the first rotating element, wherein the second rotating element comprises a protruding element; and
a base comprising a groove, wherein the groove having a size corresponded with a size of the protruding element for the protruding element to move in the groove, the groove comprises a first end and a second end; when the first rotating element and the second rotating element rotate via the first jointed structure and the second jointed structure respectively, the protruding element moves from the first end to the second end to let the first jointed structure, second jointed structure and the protruding element form a three-point support structure.

2. The hinge mechanism as claimed in claim 1, wherein the first rotating element is driven by the second rotating element to rotate and supports the second rotating element.

3. The hinge mechanism as claimed in claim 1, wherein the second rotating element is driven by the first rotating element to rotate and supports the first rotating element.

4. The hinge mechanism as claimed in claim 3, wherein the groove is tilted with a specific angle.

5. The hinge mechanism as claimed in claim 1, wherein the bearing is disposed on the base.

6. A clamshell device operable in an open state and a closed state, the clamshell device comprising:
a first cover body;
a second cover body; and
a hinge mechanism connected with the first cover body and the second cover body respectively to let the first cover body and the second cover body rotate with respect to each other, the hinge mechanism comprising:
a bearing disposed on the second cover body;
a first rotating element comprising a first jointed structure pivotally connected to the bearing for the first rotating element to rotate with respect to the bearing;
a second rotating element pivotally connected to the first rotating element via a second jointed structure for the second rotating element to rotate with respect to the first rotating element, wherein the second rotating element comprises a protruding element; and
a base disposed on the second cover body, the base comprising a groove, wherein the groove having a size corresponded with a size of the protruding element for the protruding element to move in the groove, the groove comprises a first end and a second end; when the first cover body and the second cover body rotate with respect to each other to let the clamshell device be in the open state, the first rotating element and the second rotating element rotate via the first jointed structure and the second jointed structure respectively, and the protruding element moves from the first end to the second end to let the first jointed structure, second jointed structure and the protruding element form a three-point support structure.

7. The clamshell device as claimed in claim 6, wherein when the first cover body and the second cover body rotate with respect to each other to let the clamshell device be in the closed state, the first rotating element and the second rotating element rotate via the first jointed structure and the second jointed structure to let the protruding element move from the second end to the first end.

8. The clamshell device as claimed in claim 6, wherein the first rotating element is disposed in the first cover body to drive the second rotating element to rotate along with the first rotating element.

9. The clamshell device as claimed in claim 6, wherein the second rotating element is disposed in the first cover body to drive the first rotating element to rotate along with the second rotating element.

10. The clamshell device as claimed in claim 9, wherein the groove is tilted by a specific angle.

11. The clamshell device as claimed in claim 6, wherein the bearing is disposed on the base.
